(19) United States
(12) Patent Application Publication
(10) Pub. No.: US 2025/0160243 A1
(43) Pub. Date: May 22, 2025

(54) SYSTEM FOR AUTOMATICALLY SETTING THE SET POINT OF A PLANTER AUTOMATIC DOWN PRESSURE CONTROL SYSTEM WITH A SEED FURROW SIDEWALL COMPACTION MEASUREMENT DEVICE

(71) Applicant: Deere & Company, Moline, IL (US)

(72) Inventor: Joseph D. BASSETT, Sycamore, IL (US)

(21) Appl. No.: 19/031,529

(22) Filed: Jan. 18, 2025

Related U.S. Application Data
(63) Continuation of application No. 16/740,691, filed on Jan. 13, 2020.
Application No. 16/740,691 is a continuation of application No. 15/586,743, filed on May 4, 2017, now Pat. No. 10,548,260.

(51) Int. Cl. A01C 7/20; A01B 79/00; A01C 5/06; A01C 7/06

(52) U.S. Cl. CPC A01C 7/205; A01B 79/005; A01C 5/068; A01C 5/064; A01C 7/06

(57) ABSTRACT

An agricultural row unit for planting seeds in a furrow includes an opening tool that cuts a furrow in the soil to be planted, and a gauge wheel that engages the soil to control elevation. A depth control actuator applies a controllable down force to the gauge wheel, and a sidewall compaction sensor extends into sidewalls of the furrow and produces a signal representing the compaction of the soil. A controller supplies the depth control actuator with a control signal representing a down pressure set point to form a furrow having a desired depth. The controller uses the signal representing the compaction of the soil in the sidewalls to determine whether the down pressure set point should be increased or decreased, and supplies the depth control actuator with a control signal when it is determined that the down pressure set point should be increased or decreased.

### FIELD OF THE INVENTION

The present invention relates to a system for assisting the operator of planter row units having automatic down pressure control systems to adjust the settings of such systems.

### BACKGROUND

Down pressure control systems can control the pressure based on feedback from a sensor measuring the pressure on the planter gauge wheels. For example, a farmer might set the system to keep 200 lbs of force on the gauge wheels. Then a controller increases or decreases the force from the row unit down pressure actuator so as to try to maintain the force at that set point.

Farmers frequently are confused about what the correct set point is for down pressure control. Is lighter better? There are arguments for this because an excessively compacted furrow can make it harder for the roots to grow and even result in the dreaded “Mohawk roots” where the roots grow along the length of the furrow instead of out and down. Too little sidewall compaction can also be a problem because insufficient firming of the soil in some soil conditions can result in an inconsistent vee shape to the furrow resulting in inconsistent seed placement because the vee is intended to collect the seed at the bottom of the vee. Insufficient firming can result in a furrow that falls in on itself.

### SUMMARY

In accordance with one embodiment, an agricultural row unit for planting seeds in a furrow, comprising a frame having a gauge wheel that engages the soil to control the elevation of the frame and an opening tool that cuts a furrow in the soil to be planted. A gauge wheel down force control system includes an actuator that applies a controllable down force to the gauge wheel to control the depth of the furrow. A sidewall compaction sensor extends into the furrow and into the sidewalls of the furrow and produces a signal representing the compaction of the soil in the sidewalls. A controller supplies the depth control actuator with a control signal representing a down pressure set point to form a furrow having a desired depth. The controller receives the signal representing the compaction of the soil in the sidewalls and uses the signal in an algorithm to determine whether the down pressure set point should be increased or decreased, and supplies the depth control actuator with a control signal when it is determined that the down pressure set point should be increased or decreased.

The invention also provides a method for controlling the down pressure on an agricultural row unit for planting seeds in a furrow and including a down pressure control actuator. The method supplies the down pressure control actuator with a control signal representing a down pressure set point; senses the compaction of the soil forming the sidewalls of the furrow and produces a signal representing the sensed compaction, (c) uses the signal representing the sensed compaction in an algorithm to determine whether the down pressure set point should be increased or decreased, and (d) adjusts the control signal representing a down pressure set point when it is determined that the down pressure set point should be increased or decreased.

### BRIEF DESCRIPTION OF THE DRAWINGS

FIG. 1 is a side elevation, partially schematic, of a planter row unit that includes multiple control systems.

FIG. 2 is an enlarged plan view of the sidewall compaction measuring device in the row unit of FIG. 1.

FIG. 3 is a side elevation of the sidewall compaction measuring device shown in FIG. 2.

FIG. 4 is a flow chart of an algorithm executed by the controller shown in FIGS. 1 and 3, using the output signal from the sidewall compaction measuring device.

### DETAILED DESCRIPTION OF ILLUSTRATED EMBODIMENTS

Although the invention will be described in connection with certain preferred embodiments, it will be understood that the invention is not limited to those particular embodiments. On the contrary, the invention is intended to cover all alternatives, modifications and equivalent arrangements as may be included within the spirit and scope of invention as defined by the appended claims.

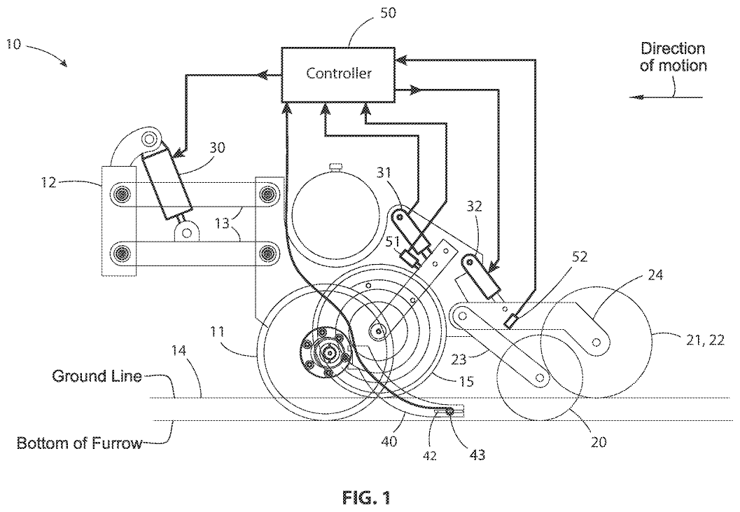

In the embodiment illustrated in FIG. 1, a planting row unit 10 includes a furrow-opening device 11 for the purpose of planting seed or injecting fertilizer into the soil. A conventional elongated hollow towing frame 12 (typically hitched to a tractor by a draw bar) is rigidly attached to the front frame of a conventional four-bar linkage assembly 13 that is part of the row unit 10. The four-bar (sometimes referred to as “parallel-bar”) linkage assembly 13 is a conventional and well known linkage used in agricultural implements to permit the raising and lowering of tools attached thereto.

As the planting row unit 10 is advanced by a tractor, the opening device 11 penetrates the soil to form a furrow or seed slot 14 having a depth D. A gauge wheel 15 determines the planting depth for the seed and the height of introduction of fertilizer, etc. The planting row unit 10 is urged downwardly against the soil by its own weight and, in addition, a hydraulic cylinder 30 is coupled between the front frame 12 and the linkage assembly 13 to urge the row unit 10 downwardly with a controllable force that can be adjusted for different soil conditions. The hydraulic cylinder 30 may also be used to lift the row unit off the ground for transport by a heavier, stronger, fixed-height frame that is also used to transport large quantities of fertilizer for application via multiple row units.

A system for controlling the down pressure applied to the row unit by the hydraulic cylinder 14 is described in U.S. Pat. No. 9,226,440, issued Jan. 5, 2016.

Bins on the row unit carry the chemicals and seed which are directed into the soil. Other portions of the row unit 10 then deposit seed in the seed slot and fertilizer adjacent to the seed slot, and the seeds are pressed into the bottom of the furrow by a firming wheel 20. The furrow is closed by a pair of closing wheels 21 and 22 that are pressed into opposite side walls of the furrow 14 to distribute loosened soil into the furrow, over the seeds in the bottom of the furrow. The firming wheel is carried on the end of an arm 23, and the closing wheels 21, 22 are carried on the end of an arm 24. The arms 23 and 24 are mounted for pivoting movement about a common axis 25, and a hydraulic cylinder 32 presses the closing wheels downwardly with a controlled pressure.

In accordance with one embodiment of the present invention, a narrow bar 40 trails the opening device 10 in the furrow 14 to monitor the hardness or compaction of the soil that forms the side walls of the furrow. The monitoring device 40 has two hard metal wings 41 and 42 that protrude laterally from the sides of the bar 40. The distance between the tips of the wings 41 and 42 is slightly longer than the width of the furrow opened by the opening device 11. The force exerted on the wings 41 and 42 by the soil in the furrow sidewalls is transmitted to a load cell 43 (or other force-measuring device), producing an electrical signal that is proportional to the strain on the wings. That strain varies with the hardness or level of compaction of the soil in the furrow sidewalls.

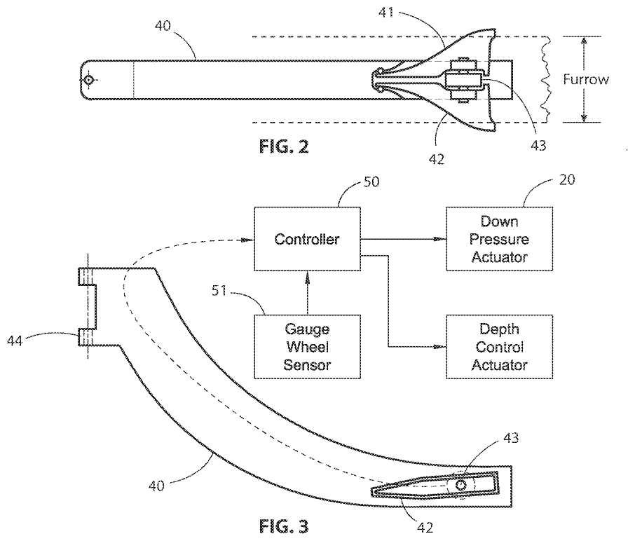

In the embodiment illustrated in FIGS. 2 and 3, the bar 40 has a yoke 44 at the upper end for attachment to the frame of the row unit. The bar 40 curves downwardly into the furrow 14 so that the trailing end of the bar slides on the bottom of the furrow, as depicted in FIG. 1. The wings 41 and 42 are mounted on the bar 40 near its trailing end, on opposite sides of a load cell 43. The distance between the outer ends of the wings 41 and 42 is smaller than the width of the furrow 14, so that the tips of the wings penetrate into the sidewalls of the furrow. The resulting forces applied to the wing tips urge the wings toward each other, thereby applying opposed forces to opposite ends of the load cell 43 located between the two wings 41 and 42. This causes the load cell 43 to produce an electrical output signal having a magnitude proportional to the forces applied to the wings, which in turn is proportional to the hardness or compaction of the soil in the side walls of the furrow.

The signal from the load cell 43 is supplied to a controller 50 that also receives input signals from sensors 51 and 52 on the support arms 53 and 24 that carry the gauge wheel 15 and the closing wheels 21, 22. The controller 50 uses these three input signals to produce three output signals that control three hydraulic cylinders 20, 31 and 32 that apply down forces to (a) the four-bar linkage for the entire row unit, (b) the arm that carries the gauge wheel 15, and (c) the closing wheels 21, 22, respectively.

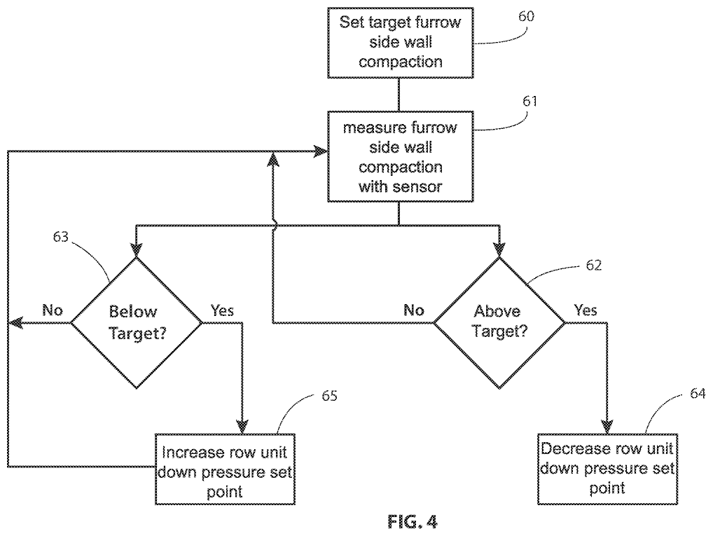

The algorithm used by the controller 20 to control the down force applied to the gauge wheel 15 compares the signal received from the load cell 43 with a target value for the sidewall compaction. One example of such an algorithm is depicted by the flow chart in FIG. 4. The first step 60 sets a target value for furrow side wall compaction. Then the actual furrow side wall compaction is measured and compared with the target value at step 61. Step 62 determines whether the measured value is more than a predetermined value above the target value, and if the answer is affirmative, the row unit down pressure set point is decreased at step 64 by sending a signal to the controller 50. Step 63 determines whether the measured value is more than a predetermined value below the target value, and if the answer is affirmative, the row unit down pressure set point is increased at step 65 by sending a signal to the controller 50. A negative answer at either step 62 or 63 returns the system to step 61.

To increase or decrease the row unit down pressure set point, the controller 50 produces an output signal that adjusts the set point of the row unit gauge wheel down force control system. For example, if the set point of down force control system is set at 200 lbs and the algorithm produces a signal to increase that set point, the down force control system increase the set point to 225 lbs. This added force on the gauge wheel increases the compression of the soil under the gauge wheel, adjacent the vee opener. If the signal from the force-measuring device is still too low, the controller 50 will receive a signal from the algorithm to increase the set point again. This process is repeated until the signal from the sidewall compaction-measuring device falls within a dead band around the set point of the row unit gauge wheel down force control system. If the signal from the compaction-measuring device is too high, the controller 50 produces an output signal that decreases the set point rather than increasing it. The control system thus prevents over-compaction of the furrow, thereby allowing optimal root growth. It also solves the operator's problem of how to set an automatic down pressure control system.

The winged device can serve multiple purposes at the same time. For example, it can act as a seed firmer by locating the bar 40 downstream of where seed is deposited in the furrow. In another example, the wings 41 and 42 can be provided with passageways that permit liquid or gas fertilizer to pass through the blades and into the grooves cut in the side of the furrow by the wings 41 and 42.

While particular embodiments and applications of the present invention have been illustrated and described, it is to be understood that the invention is not limited to the precise construction and compositions disclosed herein and that various modifications, changes, and variations can be apparent from the foregoing descriptions without departing from the spirit and scope of the invention as defined in the appended claims.

1. An agricultural row unit for planting seeds in a furrow, comprising
a frame having (a) a gauge wheel that engages the soil to control the elevation of the frame and (b) an opening tool that cuts a furrow in the soil to be planted,
a gauge wheel down force control system that includes an actuator applying a controllable down pressure to said gauge wheel to control the depth of said furrow,
a sidewall compaction sensor extending into the furrow and into the sidewalls of the furrow and producing a signal representing the compaction of the soil in said sidewalls, and
a controller supplying said actuator with a control signal representing a down pressure set point to form a furrow having a desired depth, said controller receiving said signal representing the compaction of the soil in said sidewalls and using said signal in an algorithm to determine whether said down pressure set point should be increased or decreased, and supplying said actuator with a control signal when it is determined that said down pressure set point should be increased or decreased.
